(19) United States
(12) Patent Application Publication
(10) Pub. No.: US 2004/0204819 A1
(43) Pub. Date: Oct. 14, 2004

(54) Traffic control method and apparatus

(76) Inventor: Weiping Meng, Flushing, NY (US)

Correspondence Address: Weiping Meng, 133-34 41st Avenue, #2A, Flushing, NY, 11355, US

(21) Appl. No.: 10/486,952

(22) PCT Filed: Aug. 16, 2001
(86) PCT No.: PCT/CN01/01228

(51) Int. Cl. G06F 19/00

(52) U.S. Cl. 701/117

(57) ABSTRACT

A method called as a time-differential-ratio method and its apparatus used for intersection traffic control that differentially operates on the traffic so as to change pass-permit direction with traffic status in time is disclosed. The method includes the steps of starting, timing, vehicle-requesting, extra-moving, ratio-moving, and recycling. Unlike a common control method called as macro-estimate control method that forces changeable traffic to follow a given period and direction turn order to pass, which causes lots of stops and wait, a differential operations on the traffic are integrated with a common ratio control method and walker signals. It shows the operating features and the effective characteristic of both micro-time control and macro ratio control, which lets a vehicle arriving first pass first conditionally, is good for real-time arbitrary traffic pattern control, and leads to great reduction of stops and wait. The apparatus needed for the method includes sensing/detecting apparatuses and processing apparatus.

### CROSS REFERENCE TO RELATED APPLICATIONS

(Not Applicable)

### FEDERALLY SPONSORED RESEARCH/DEVELOPMENT

(Not Applicable)

### BACKGROUND OF THE INVENTION

### (TECHNICAL FIELD AND PRIOR ART)

The present invention relates to a method and its apparatus for intersection traffic control. More particularly, the present invention relates to a time-differential-ratio method and its apparatus for intersection traffic control.

The most common traffic control apparatus for an intersection consists of a subapparatus for signal control and a subapparatus for signal colored display: Red-Stop, Yellow-Slow, Green-Move, and its deriving Left, Right, and Walk signals. There are two signal control methods widely used with the apparatus: RATIO and DRIVE.

RATIO is: setting up a permit time for every direction according to some ratio, for example, a ratio of north-south over east-west in traffic volumes; initially after traffic-cleaning for some time giving the only pass-permit to a direction; then turning the permit to the next direction with its corresponding permit time in certain order from the initial direction on when the permit time of a current pass-permit direction runs out. A road net using RATIO usually requires identical parameters. Note: hereinafter, the only pass-permit is simply called as permit.

DRIVE is: based on RATIO parameter-initiation and turn order, setting up a direction as a driving direction in which the start time of the Green-Move of a downstream intersection in the driving direction is delayed by some quantity compared to its upstream, for example, the quantity to take a vehicle from its upstream one to the downstream. The control performance of a road net using DRIVE is better than RATIO. DRIVE can control multiple, parallel, opposite directions traffic in different roads through its control area.

Both methods belong to a macro-estimate control method. A road-net using RATIO or DRIVE shows integral in operation, macro in time, slow and hard in response to changeable traffic. The leading disadvantage of them is that they are unable to grant a permit to a vehicle arriving first but always force vehicles arriving stochastically to follow their permit period and direction turn order. Furthermore they always force the whole controlled road net area with different local traffic characteristics to follow the period and the order, which causes lots of stops and waiting time.

Many micro-time control methods are proposed and being tested in order to overcome this disadvantage of the current macro-estimate techniques. According to their limited disclosure, none of these methods are practical or effective. The common disadvantages of them are: 1) they produce technique-inherent traffic jam due to their intersection's being neither capable of coordinating nor easy to coordinate with their adjacent intersection; 2) communication function or central control, by which one could solve the traffic jam, are harder to fulfill for changeable traffic or extend; 3) they have a smaller changeable time ratio with bigger response time for tracing traffic patterns; 4) they have narrower scope for traffic pattern recognition; 5) they have limited practical requirements based on mathematical method and limit for its optimization; 6) the trouble and impossibility of proper integrity with walk signals, and so on.

### BRIEF SUMMARY OF THE INVENTION

It is an object of the present invention to provide a time-differential-ratio method and its apparatus for traffic control in order to avoid the previously said shortcomings of all the current, tested, and proposed techniques.

More particularly, it is an object of the present invention to provide a method and its apparatus that is both able to dynamically dispatch permit and micro-adjust permit time with reference to traffic-status in all controlled directions and able to integrate these dynamic-micro-operations with the common RATIO method. So, the present invention has the operating features and the effective characteristic of both micro-time control and macro ratio control, by which a vehicle arriving first may be granted a permit first conditionally. Riemann Sum is here cited as and applied for theoretical foundation for this object. This micro time can be optimized on Riemann Sum theory. In order to meet some typical traffic feature demands, the present invention includes two correlated methods and their apparatus: method-1 is basic for vehicles only and method-2 including method-1 is used for vehicles and walkers.

In keeping with the object, one feature of the present method-I invention resides in:

A method for intersection traffic control includes the steps of:

(1) Starting: setting Ratio-Move as initial state and setting up all the other necessary parameters;

Note: the present method invention includes two operating states, Ratio-Move and Extra-Move. Ratio-Move follows RATIO given above; but Extra-Move occupies some time of Ratio-Move and inserts an Extra-Direction beyond the turn order of Ratio-Directions; a Ratio-Direction holds a Ratio-Move permit; an Extra-Direction holds an Extra-Move permit; a permit consists of Move, Watch, and Clean; a permit time=move time +watch time +clean time; all steps or sub-steps are numbered with double parenthesis;

(2) Time Processing: measuring time; if a time unit is not obtained, run step (6) or (2);

(3) Vehicle Request Processing: deciding if an Extra-Move permit is granted with reference to the state and its direction;

(4) Extra-Move Processing: measuring Extra-Move time from the Extra-Move permitted and changing the permit when needed;

(5) Ratio-Move Processing: measuring Ratio-Move time from the Ratio-Move permitted and changing the permit when needed;

(6) Recycling: running step (2) directly or adding some sub-processes before it.

Another feature of the present method-1 invention is that included in step (3) are the sub-steps of:

(3.a) if the state is Ratio-Move and there is no vehicle-request in the Ratio-Direction, a vehicle request in another direction will receive a Extra-Move quasi-permit and certain time with a related time subtracted from the permit time of the Ratio-Direction; if the permit time is not sufficient, the offset is subtracted from the permit time of the next Ratio-Direction with whose replacing the Ratio-Direction, set the state as Extra-Move;

Note: “there is no vehicle-request in a Ratio-Direction” means “, neither in its opposite”, hereinafter;

said quasi-permit will become an Extra-Move permit after the extra-watch time of a Ratio-Direction runs out;

said extra-watch time is set for possible vehicles in the Ratio-Direction to brake before the permit is turned to an Extra-Direction; it may be set to 0;

said certain time should be smaller than 10 sec or relates to the limit speed in the controlled direction;

said related time is the sum of said certain time and extra-watch time when the Ratio-Move permit time doesn't reach its watch time or just is the said certain time;

(3.b) skip step (3), or, if the state is Extra-Move and

(3.b.1) if there is a vehicle request in the Ratio-Direction, run step (4);

(3.b.2) skip step (3), or, if there is a vehicle request in a non-Extra-Direction and the next Extra-Direction is null, let the non-Extra-Direction be the next Extra-Direction, run step (3.b.4);

(3.b.3) skip step (3), or, keeping the permit for new vehicle requests in the Extra-Direction, and

(3.b.4) give the direction certain time with the time subtracted from the permit time of the Ratio-Direction; if the permit time is not sufficient, the offset is subtracted from the permit time of the next Ratio-Direction with whose replacing the Ratio-Direction

Another feature of the present method-1 invention is that included in step (4) are the sub-steps of:

(4.a) if the state is Ratio-Move, run step (5);

(4.b) if there is extra-watch time, take off one unit from it, run step (6); otherwise, turn the quasi-permit into a Extra-Move permit, that is, change the permit direction from the previous Ratio-Direction into the Extra-Direction and set the permit as Move;

(4.c) if Extra-Move still has its permit time to run, take off one time unit from the time; if not, if the next Extra-Direction is not null, turn the Extra-Move permit to it, i.e., let the next Extra-Direction replace the Extra-Direction and the next Extra-Direction null; else turn the permit to the Ratio-Direction entering Ratio-Move, and run step (5);

(4.d) if the Extra-Move permit time reaches Extra-Move watch permit time, turn the permit into Watch;

(4.e) run step (6);

Another feature of the present method-1 invention is that said certain time in sub-step (3.a) should, under the guarantee of traffic safety, with relating to the limit speed in the corresponding direction, be as small as possible, usually smaller than 10 seconds;

In keeping with the object, one feature of the present method-2 invention resides in:

A method for intersection traffic control includes method-1 and the steps of: see FIG. 1,

(21) Walk Request Processing: deciding if a walk-permit is granted with referring to the state and its direction;

Note: hereinafter, (21) means that the step (21) should be inserted between step (2) and (3), so reasoningly, (201) between (2) and (21), (22) between (21) and (3), (211) between (21) and (22), (31) between (3) and (4), and so on;

(31) Walk Processing: measuring walk-time from walk-permit and changing the permit if needed;

Another feature of the present method-2 invention is that included in step (21) are the sub-steps of:

(21.a) if the state is Ratio-Move and permit is Move and the rest time of Move is sufficient for walkers to cross, give a walk permit to any walk request in a non-Ratio-Direction and the corresponding time;

Another feature of the present method-2 invention is that included in step (3) are all the sub-steps in method-1 step (3) but with steps (3.a) and (3.b.1) redefined as:

(3.a) if the state is Ratio-Move and there is no vehicle-request in the Ratio-Direction and no walk requests in the other directions, a vehicle request in another direction will receive an Extra-Move quasi-permit and the said certain time with the said related time subtracted from the permit time of the Ratio-Direction; if the permit time is not sufficient, the offset is subtracted from the permit time of the next Ratio-Direction with whose replacing the Ratio-Direction, set the state as Extra-Move;

(3.b.1) if there is a vehicle request in the Ratio-Direction or walk requests in non-Ratio-Directions, run step (4);

In keeping with the present method-2 invention, one feature of the present apparatus-2 invention, resides in:

An apparatus for intersection traffic control includes: apparatus for vehicle requests called as Requester, analysis apparatus as Analyzer, apparatus for traffic signal display as Displayers, and apparatus for walk requests called as W-Requester; W-Requesters and Requesters take walker's and vehicle's requests and send them to Analyzer; After analyzing these requests, Analyzer, which may be local, distributed, remote, or centered, sends the analysis results as traffic signals to Displayers in every directions;

Requesters includes a sensing/detecting apparatus that is capable of recognizing vehicle's distance from it within certain range; Note: a sensing/detecting apparatus in this specification can be an apparatus with any changer for energy/electricity: from a receiver or transducer for any kind of electromagnetic waves such as light, infrared, Piezo transducers of sound, even to button-switches;

W-Requesters includes a sensing/detecting apparatus that is capable of recognizing walker's distance from it within some range;

The Analyzer at least includes a Request-Inputor, a Processor, a Signal-Outputor; Request-Inputor collects walk's requests from W-Requesters and vehicle's requests from Requesters in every direction and delivers them into Processor; after processing, Processor sends results through Signal-Outputor to Displayers which shows the change of traffic signals.

Another feature of the present apparatus-2 invention resides in: said certain range of Requesters should, under the guarantee of traffic safe, with relating to the limit speed in the corresponding direction, be as small as possible, usually smaller than 50 meters.

The advantages of the present invention are below: I. Independent but cooperative run: the running of a machine of the present invention only need collecting and analyzing local micro-traffic status of where the machine is controlling and relates neither to the information from other intersections nor any other control apparatus; despite this independency the adjacent intersections using the present invention can still cooperate easily with one another.

II. Reserved rights for walkers: due to maintaining the operating features of RATIO with Walker that signals dynamically, by setting up permit-priority order of walker and Extra-Move, the rights for walker are reserved basically like the ones under regular RATIO.

III. Real time large scale changeable control ratio (0,∞) with mini-response-time for tracing intersection traffic arrival distribution: dynamical micro time permit dispatching operations with the change of traffic distribution among controlled directions, depicted previously, minimizes response time of local traffic, maximizes the time-ratio, from almost zero ratio to infinite tracing the traffic load, and leads the best control performance for an intersection based on the theory of Riemann Sum. Irregular changes and distribution are recorded for traffic load characteristics at intersections. The Extra-Move basic time given previously is viewed as a time-difference. The total throughput over a period is a Riemann Sum or a discrete definite integral of instant throughput in all controlled directions over time, whereas total arrivals over a period is a Riemann Sum of instant arrival rates in all controlled directions over time. Naturally the less the time-difference, the more flexible the present invention operates, then the more closing or similar to the previously said arrival curve the throughput curve is, and the better performance it means. But too small a time difference will practically cause vehicle collisions. With the tradeoff of theoretically performance and applicability, an acceptable extreme for the best solution may be determined.

IV. Automatically real-time traffic flow pattern recognition: the road net system using the present invention as basic control units for their intersections shows the capability of easily-coordinating, easily-extending, simultaneously multiple-direction driving, multiple-sub-areas driving, multiple-polylines driving, matching with any traffic flow pattern. It also shows the capability of timely, automatically and smoothly changing the driving directions, sub-areas and their borders, polylines and their borders with corresponding traffic demands: real-time matching with arbitrary traffic flow pattern under the load lower than near-saturated traffic load. These reduce and postpone traffic jam. The road net under near-saturated traffic loads or greater follows RATIO automatically, and can further be improved and optimized under those loads by using road net systematic traffic engineering controls.

V. The best road net system for modern traffic control derived on the Riemann Sum theory: the road net system given in IV just meets modem traffic changeable demands for multiple-direction flow, multiple-sub-area flow, and multiple-polyline flow in an intersection-arbitrarily-distributed road-net mixing plane-crossings with solid-crossings. Whereas the road net is an area-difference time-difference ratio control system, a sub-area is regarded as an area-difference. The less the area-difference, the more closing or similar to an area-traffic distribution curve surface the instant area-throughput distribution curve surface is, then the better performance it means. The practical extreme for an area-difference just is an intersection using the present invention that has already optimized the performance.

### BRIEF DESCRIPTION OF THE DRAWINGS

FIG. 1 is a flowchart of method-2;

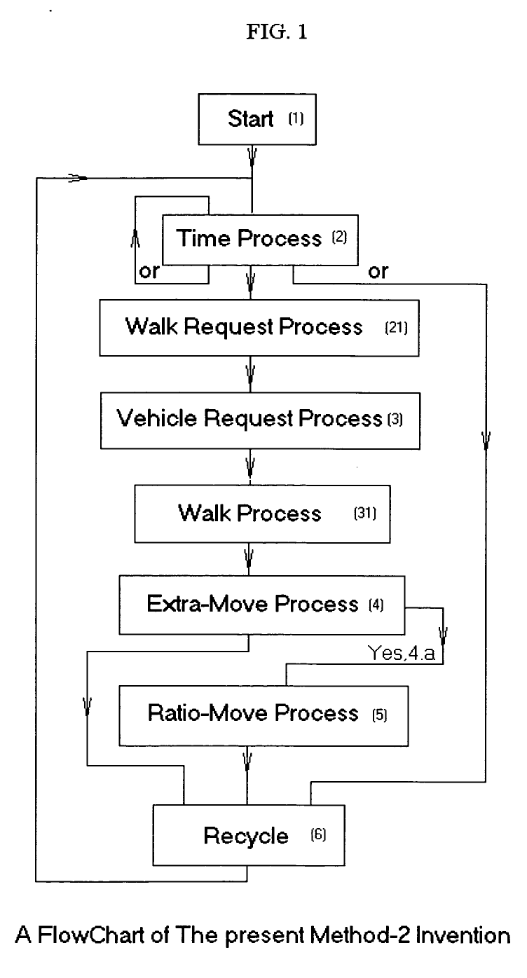

FIG. 2 is a flowchart of one of the method-2-based 8051 program best embodiments;

FIG. 3 is a schematic of an apparatus-2-based and 8051-cored embodiment;

FIG. 4 is a draft for mounting all the apparatus of an apparatus-2-based embodiment.

### LIST OF REFERENCE NUMERAL UTILIZED IN THE DRAWING

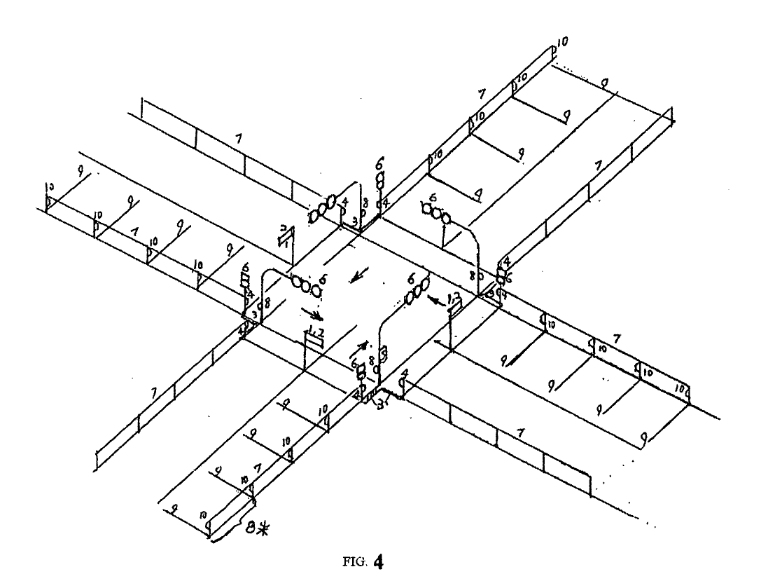

In FIG. 4:

#1, a 0-3 meter near ultrasonic detector in a Requester of Embodiment 3;

#2, a 4-32 meter far ultrasonic detector in a Requester of Embodiment 3;

#3, a pedal switches in a W-Requester of Embodiment 3;

#4, a button switches in a W-Requester of Embodiment 3;

#5, an Analyzer;

#6, a Displayer;

#7, fence;

#8, a light detector in a Requester of Embodiment 3;

#9, a weight switches in a Requester of Embodiment 2;

#10, a light detector in a W-Requester of Embodiment 2;

### DETAILED DESCRIPTION OF THE INVENTION

### (Description Of The Preferred Embodiments, Industry Applications)

List of the parameters, their unit, and their evaluation in the following embodiments:

a. time unit TU: sec., TU=1;

b. limit speed vs: meter/sec., 8; Note: usually, non-homogenous;

c. Ratio-Move clean time RTC: sec., RTC=1; Note: RTC=roadwidth/vs;

d. Ratio-Move watch time RTW: sec., RTW=4;

e. Extra-Move clean time ETC: sec., ETC=0; Note: ETC=roadwidth/vs;

f. Extra-Move watch time ETW: sec., ETW=2; Note: ETW relates to vs;

g. time differential dt: sec, dt=4;

h. detecting distance for vehicles vsed: m., vsed=32; Note: vsed=vs * dt;

i. detecting-distance for walkers wsed: m., wsed=0;

j. walk speed ws: m/sec., 1; Note: option for handicap speed hs=0.5;

k. walk-pass time wpt: sec., wpt=10; Note: wpt=roadwidth/ws;

l. ratio-period RP: sec., RP=60;

m. ratio R: R=½;

n. Move=green signal;

o. Watch=yellow signal;

p. Clean=red signal;

q. stop=red signal;

r. default extra-watch time betw: sec, betw=2;

s. extra-watch time etw: sec, etw=0;

Embodiment 1:

A frame of a method-2-based 8051 program embodiment as following:

(1) Starting:

(1.a) set Ratio-Move as initial state;

(2.b) the default permit time in main-direction=30, and equally distribute the rest time of the 60 sec-period to the other directions; Note: main-direction means that its default permit time is guaranteed for a given ratio and period, hereinafter;

(1.c) set up signal “Red-Stop” in all directions, let the main-direction be the next Ratio-Direction, and let all permit times be zero;

(1.d) set up all the other necessary parameters, including all in the previous List;

(2) Time Processing: measure time; if a time unit is not obtained, run step (6);

(201) checking the state: if it is Extra-Move, run step (4);

(202) taking walk-requests: check if walker requests: if yes, save them for processing;

(203) taking vehicle-requests: check if vehicle requests: if yes, save them for processing;

(21) Walk Request Processing:

(21.a) if the state is Ratio-Move and permit is Move and the rest time of Move is sufficient for walker to cross, give walk-permits to any walk request in a non-Ratio-Direction and the corresponding time;

(3) Vehicle Request Processing:

(3.a) if the state is Ratio-Move and there is no vehicle-request in the Ratio-Direction and no walk requests in the other directions, a vehicle request in another direction will receive an Extra-Move quasi-permit and the said time differential with a related time subtracted from the permit time of the Ratio-Direction; if the permit time is not sufficient, the offset is subtracted from the permit time of the next Ratio-Direction with whose replacing the Ratio-Direction;

Said related time is the sum of the said time differential and extra-watch time if the Ratio-Move permit time doesn't reach its watch time or just is the said time differential;

(31) Walk Processing:

(31.a) if the walk permit time>0, subtract one time unit from the time;

(31.b) if the walk permit time>0, keep the holding permit in all the non-Ratio-Directions, if no, stop walking;

(4) Extra-Move Processing:

(4.a) if the state is Ratio-Move, run step (5);

(4.b) if there is extra-watch time, take off one unit from it, run step (6); otherwise, turn the quasi-permit into a Extra-Move permit, that is, change the permit direction from the Ratio-Direction into the Extra-Direction and set the permit as Move;

(4.c) if Extra-Move permit time>0, subtract one time unit from the time; if not, if the next Extra-Direction is not null, turn the Extra-Move permit to it, this is, let the next Extra-Direction replace the Extra-Direction and the next Extra-Direction null; else turn the permit to the Ratio-Direction entering Ratio-Move, run step (5);

(4.d) if the Extra-Move permit time=Extra-Move watch time, turn the permit into Watch;

(4.d.1) sends off control signals to Displayer in every direction;

(4.e) run step (6);

(5) Ratio-Move Processing: measure Ratio-Move time from the Ratio-Move permitted, change the permit if needed;

(5.a) if the Ratio-Direction permit time>0, subtract one time unit from the time;

(5.b) if the Ratio-Direction permit time=Ratio-Move watch time, turn the permit into Watch and stop walking;

(5.c) if the Ratio-Direction permit time=the Ratio-Direction clean time, turn the permit into Clean;

(5.d) if the Ratio-Direction permit time=0, turn the permit to the next Ratio-Direction;

(51) send off control signals to Displayer in every direction;

(52) command Requesters to send off detecting signals for vehicles;

(6) Recycling:

(6.a) check if vehicle requests: if yes, save them for processing, if no, if check time expires, end it;

(6.b) run step (2) directly.

Embodiment 2:

A frame of one of the method-2-based 8051 program best embodiments as following:

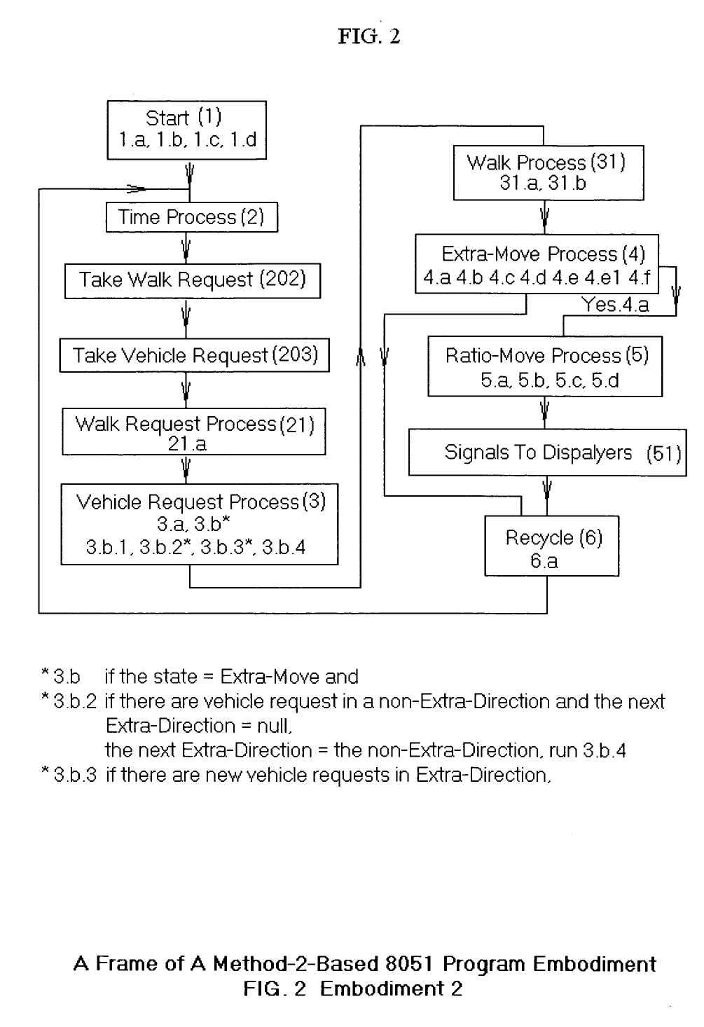

See FIG. 2, based on embodiment 1, choose “run step (2)” in step (2) of method-2, add steps (3.b.1), (3.b.2), (3.b.3), and (3.b.4), take off step (201), (52), and (6.a), then the new embodiment is obtained, which is one of the best embodiments.

Embodiment 3:

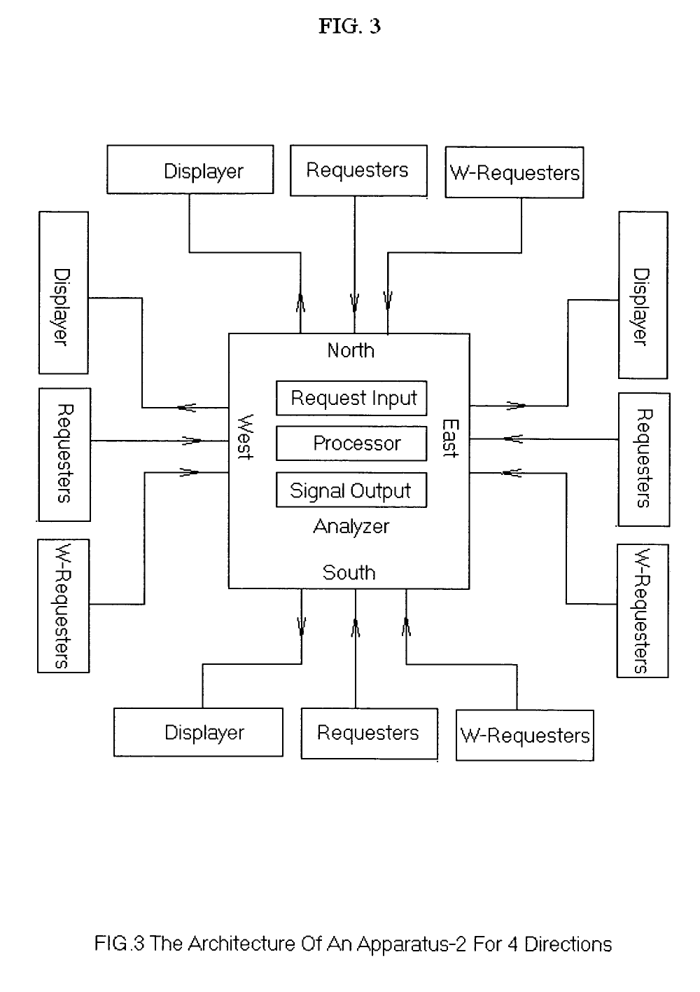

An apparatus-2-based and 8051-cored embodiment for normal 2-4 directions intersections as following, see FIGS. 3, 4:

Analyzer: see FIG. 3,

Request-Inputor: 4x 74LS21, 74LS04, 74LS08, 3x 74LS32, [ULN2003A, 4x G2RL]

Processor: AT89C52, 74LS04

Signal-Outputor: 3x 74LS08, 2x 74LS373, [2x ULN2003A, 10x G2RL]

Requesters: in every signal-control direction there are installed one apparatus for lifting voltage, called as voltage-lifter, and two ultrasonic Piezo distance-measuring apparatuses, called as distance-measurer; one of the two distance-measurers is for a vehicle in 0-8 meters distance from it, the other for those in 9-32 meters, and the voltage-lifter is wire-connected to a voltage-lifter of Analyzer in order for Analyzer to control Requesters by its weak digital-signals; in order to avoid a mis-signal from arbitrarily-road-crossing walkers, 32-meter-long secure fence is set up;

W-Requesters: a pedal switch and a button-switch are installed at the waiting position of official walk-crossing way with wire-connection to Analyzer; the switch signals are walker requests; in order to avoid a mis-signal from arbitrary walkers, the pedal size had better be not lager than 0.1 meter×1.5 meter;

Displayers: common traffic signal displayers;

A draft for mounting, see FIG. 4.

What is claimed as new and desired to be protected by Letters Patent is set forth in the following

1. A method for intersection traffic control includes the steps of:
(1) Starting: setting Ratio-Move as initial state; and setting up all the other needed parameters;
(2) Time Processing: measuring time, if a time unit is not obtained, run step (6) or (2);
(3) Vehicle Request Processing: deciding if an Extra-Move permit is granted with reference to the state and its direction;
(4) Extra-Move Processing: measuring Extra-Move time from the Extra-Move permitted and changing the permit when needed;
(5) Ratio-Move Processing: measuring Ratio-Move time from the Ratio-Move permitted and changing the permit when needed;
(6) Recycling: running step (2) directly or adding some sub-processes before it;
Said Ratio-Move is a state that follows RATIO;
Said Extra-Move is the other state that occupies some time of Ratio-Move and inserts an Extra-Direction beyond the turn order of Ratio-Directions;
Said Ratio-Direction holds a Ratio-Move permit;
Said Extra-Direction holds an Extra-Move permit;
Said permit comprises Move, Watch, and Clean;
Said permit time=move time+watch time+clean time;
Said RATIO is the most common method of intersection traffic control. It sets up a permit time for every direction according to some ratio, e.g., a ratio of north-south traffic volume over east-west; initially after traffic-cleaning for some time, it gives the only pass-permit to a direction; then it turns the only one permit to the next direction with its corresponding permit time in certain order from an initial direction on when the permit time of a current permitted direction runs out.

2. A method as defined in claim 1, wherein step (3) includes the sub-steps of:
(3.a) if the state is Ratio-Move and there is no vehicle-request in the Ratio-Direction, a vehicle request in another direction will receive an Extra-Move quasi-permit and certain time with a related time subtracted from the permit time of the Ratio-Direction; if the permit time is not sufficient, the offset is subtracted from the permit time of the next Ratio-Direction with whose replacing the Ratio-Direction, set the state as Extra-Move;
Said “there is no vehicle-request in the Ratio-Direction” means “, neither in its opposite”, hereinafter;
Said quasi-permit will become an Extra-Move permit after the extra-watch time of a Ratio-Direction runs out;
Said extra-watch time is set for possible vehicles in the Ratio-Direction to brake before the permit is turned to an Extra-Direction; it may be set 0;
Said certain time should be smaller than 10 sec or relates to the limit speed in the controlled direction;
Said related time is the sum of said certain time and extra-watch time when the Ratio-Move permit time doesn't reach its watch time or just is the said certain time;
(3.b) skip step (3), or, if the state is Extra-Move and
(3.b.1) if there is a vehicle request in the Ratio-Direction, run step (4);
(3.b.2) skip step (3), or, if there is a vehicle request in a non-Extra-Direction and the next Extra-Direction is null, let the non-Extra-Direction be the next Extra-Direction, run step 3.b.4;
(3.b.3) skip step (3), or, keeping the permit for new vehicle requests in the Extra-Direction, and
(3.b.4) give the direction certain time with the time subtracted from the permit time of the Ratio-Direction; if the permit time is not sufficient, the offset is subtracted from the permit time of the next Ratio-Direction with whose replacing the Ratio-Direction.

3. A method as defined in claim 1, wherein step (4) includes the sub-steps of:
(4.a) if the state is Ratio-Move, run step (5);
(4.b) if there is extra-watch time, take off one unit from it, run step (6); otherwise, turn a quasi-permit into a Extra-Move permit, that's, change the permit direction from the Ratio-Direction into the Extra-Direction, and set the permit as Move;
(4.c) if Extra-Move still has its permit time to run, take off one time unit from the time; if not, if the next Extra-Direction is not null, turn the Extra-Move permit to it, i.e., let the next Extra-Direction replace the Extra-Direction and the next Extra-Direction null; else turn the permit to the Ratio-Direction entering Ratio-Move, run step (5);
(4.d) if the Extra-Move permits time reaches Extra-Move watch time, turn the permit into Watch;
(4.e) run step (6).

4. A method as defined in claim 2, said certain time should, under the guarantee of traffic safe, with relating to the limit speed in the corresponding direction, be as small as possible, usually smaller than 10 seconds.

5. A method for intersection traffic control includes a method as defined in claim 2 and the steps of:
(21) Walk Request Processing: deciding if a walk-permit is granted with referring to the state and its direction;
(31) Walk Processing: measuring walk-time from walk-permit and changing the permit if needed;
Said (21) means that the step (21) should be inserted between step (2) and (3), so reasoning, (31) between (3) and (4), and (201) between (2) and (21), and (22) between (21) and (3), (211) between (21) and (22), (31) between (3) and (4), and so on: step (xy) should be between step (x) and (x+1) also between step (x[y−1]) and (x[y+1]) if needed. Said x and y are digits: 0-9.

6. A method as defined in claim 5, wherein step (21) includes the sub-steps of:
(21.a) if the state is Ratio-Move and permit is Move and the rest time of Move is sufficient for walker to cross, give a walk permit to any walk request in a non-Ratio-Direction with the corresponding time.

7. A method as defined in claim 5, wherein step (3) includes all the sub-steps of step (3) with its sub-steps (3.a) and (3.b.1) redefined as:
(3.a) if the state is Ratio-Move and there is no vehicle-request in the Ratio-Direction and no walk requests in the other directions, a vehicle request in another direction will receive an Extra-Move quasi-permit and the said certain time with the said related time subtracted from the permit time of the Ratio-Direction; if the permit time is not sufficient, the offset is subtracted from the permit time of the next Ratio-Direction with whose replacing the Ratio-Direction, set the state as Extra-Move;
(3.b.1) if there is a vehicle request in the Ratio-Direction or walk requests in non-Ratio-Directions, run step (4).

8. An apparatus for intersection traffic control for a method as defined in claim 5 includes: apparatus for vehicle requests called as Requester, analysis apparatus as Analyzer, apparatus for traffic signal display as Displayer, and apparatus for walk request called as Walk-Requester; said Walk-requesters and said Requesters take walker's and vehicle's requests and send them to said Analyzer; after analyzing these requests, Analyzer, which may be local, distributed, remote, or centered, sends the analysis results as traffic signals to Displayers in every directions;
Said Requester includes a sensing/detecting apparatus that is capable of recognizing vehicle's distance from it within certain range;
Said Walk-requester includes a sensing/detecting apparatus that is capable of recognizing walker's distance from it within some range;
Said Analyzer includes a Request-Inputor, a Processor, a Signal-Outputor; said Request-Inputor collects walker's requests from said Walk-Requesters and vehicle's requests from said Requesters in every direction and delivers them into said Processor; after processing, said Processor sends results to said Signal-Outputor which controls the change of traffic signals in said Displayers.

9. An apparatus as defined in claim 8, said certain range of Requesters should, under the guarantee of traffic safe, with relating to the limit speed in the corresponding direction, be as small as possible, usually smaller than 50 meters.
